(19) United States
(12) Patent Application Publication
(10) Pub. No.: US 2022/0032175 A1
(43) Pub. Date: Feb. 3, 2022

(54) NON-TRANSITORY COMPUTER-READABLE MEDIUM INCLUDING CIRCULATION CONTROL PROGRAM, AND NON-TRANSITORY COMPUTER-READABLE MEDIUM INCLUDING CIRCULATION CONTROL SYSTEM AND COMMUNICATION CONTROL PROGRAM

(71) Applicant: SQUARE ENIX CO., LTD., Tokyo (JP)

(72) Inventor: Yu WATANABE, Tokyo (JP)

(73) Assignee: SQUARE ENIX CO., LTD., Tokyo (JP)

(21) Appl. No.: 17/443,978

(22) Filed: Jul. 29, 2021

(30) Foreign Application Priority Data
Aug. 3, 2020 (JP) 2020-131447

(51) Int. Cl. A63F 13/216; A63F 13/44; A63F 13/79; A63F 13/31; A63F 13/65; A63F 13/69

(52) U.S. Cl. CPC A63F 13/216; A63F 13/44; A63F 13/79; A63F 2300/8064; A63F 13/65; A63F 13/69; A63F 2300/8094; A63F 13/31

(57) ABSTRACT

A non-transitory computer-readable medium including a circulation control program for causing a server device controlling a progress of making each of the plurality of users circulate a plurality of destinations to implement the following functions including an update function of updating user information of each of a plurality of users registered in a storage unit, the user information including history information specifying an already visited destination and designation information specifying a designated destination to be visited, and a designation function of determining the designated destination for each of a plurality of users, the designation function determining, based on the history information of one user, one destination that the one user has not visited yet as the designated destination of the one user, and transmitting information on the designated destination to a terminal device of the one user.

### CROSS-REFERENCE TO RELATED APPLICATION(S)

This application claims priority to and the benefit of Japanese Patent Application No. 2020-131447, filed on Aug. 3, 2020, the disclosure of which is expressly incorporated herein by reference in its entirety for any purpose.

### BACKGROUND

At least one of the embodiments of the present invention relates to a non-transitory computer-readable medium including a circulation control program, and a non-transitory computer-readable medium including a circulation control system and a communication control program.

In recent years, smart devices such as smartphones and tablet terminals that can be carried by users have become widespread. Events such as a treasure hunt game using such smart devices are also actively held. The treasure hunt game is an event in which participants solve a plurality of mysteries (questions) and search for treasure hidden in the real space. The treasure is disposed at a predetermined position in the real space. The participants can specify where the treasure is disposed by solving a plurality of mysteries. In the treasure hunt game, the participants need to go around a plurality of places on foot or the like to acquire all the hidden treasures. The above-described event is a circulating type (migratory type) event in which the participants go around a plurality of places (destination).

Since the participants go around a plurality of places, the above-described events are held at commercial facilities such as a shopping street for the purpose of sales promotion. Accordingly, the place (destination) where the treasure or the like is disposed may also be a part of a region of a certain store. An example of related art may be found in JP-A-2004-126689.

### SUMMARY

In a case where participants go around a plurality of places (destinations) as described above, or in a case where the participants go around each destination in a predetermined order, when the participants all visit the same destination at the same time, there is a possibility that the destination may be congested. There is a demand to avoid congestion as much as possible since a large space is not always secured in a place set as a destination.

An object of at least one embodiment of the present disclosure is to solve a shortage of related technology.

According to a non-limiting viewpoint, a non-transitory computer-readable medium according to an embodiment of the present disclosure includes a circulation control program for causing a server device that is connected to a terminal device carried by each of a plurality of users through a communication network, the server device controlling a progress of making each of the plurality of users circulate a plurality of destinations, to implement the following functions including an update function updating user information of each plurality of users registered in a storage unit, the user information including history information specifying an already visited destination and designation information specifying a designated destination to be visited, and a designation function of determining the designated destination for each of a plurality of users, the designation function determining, based on the history information of one user, one destination that the one user has not visited yet as the designated destination of the one user, and transmitting information on the designated destination to a terminal device of the one user, in which the update function may include a function of updating the history information of one user when information indicating visiting the designated destination is received from the terminal device of the one user, and a function of updating the designation information of one user when the designated destination of the one user is determined by the designation function, and the designation function may include a function of determining the designated destination according to a congestion status of the plurality of destinations based on at least the designation information of each user.

According to a non-limiting viewpoint, a circulation control system according to an embodiment of the present disclosure is a circulation control system for controlling a progress of making each of a plurality of users circulate a plurality of destinations, the circulation control system including a terminal device carried by each of the plurality of users, and a server device connected to the terminal device through a communication network, the circulation control system including an updater configured to update user information of each of a plurality of users registered in a storage unit, the user information including history information specifying an already visited destination and designation information specifying a designated destination to be visited, and a designator configured to determine the designated destination for each of a plurality of users, the designator determining, based on the history information of one user, one destination that the one user has not visited yet as the designated destination of the one user, and transmitting information on the designated destination to a terminal device of the one user, in which the updater updates the history information of one user when information indicating visiting the designated destination is received from the terminal device of the one user, and updates the designation information of one user when the designated destination of the one user is determined by the designator, and the designator determines the designated destination according to a congestion status of the plurality of destinations based on at least the designation information of each user.

According to a non-limiting viewpoint, a non-transitory computer-readable medium according to an embodiment of the present disclosure includes a communication control program for causing a terminal device carried by each of a plurality of users to implement the following functions, for communicating with a server device having a function of controlling a progress of making each of the plurality of users circulate a plurality of destinations, the program causing the terminal device to implement a function of receiving information on a designated destination from the server device having the following functions including an update function of updating user information of each of a plurality of users registered in a storage unit, the user information including history information specifying an already visited destination and designation information specifying a designated destination to be visited, and a designation function of determining the designated destination for each of a plurality of users, the designation function determining, based on the history information of one user, one destination that the one user has not visited yet as the designated destination of the one user, and transmitting information on the designated destination to a terminal device of the one user, in which the update function may include a function of updating the history information of one user when information indicating visiting the designated destination is received from the terminal device of the one user, and a function of updating the designation information of one user when the designated destination of the one user is determined by the designation function, and the designation function may include a function of determining the designated destination according to a congestion status of the plurality of destinations based on at least the designation information of each user.

Each embodiment of the present application solves one or more shortages.

### BRIEF DESCRIPTION OF THE DRAWINGS

FIG. 1 is a block diagram showing an example of a configuration of a circulation control system corresponding to at least one of the embodiments of the present disclosure.

FIG. 2 is a functional block diagram showing a configuration of a server device corresponding to at least one of the embodiments of the present disclosure.

FIG. 3 is a flowchart showing an example of circulation processing corresponding to at least one of the embodiments of the present disclosure.

FIG. 4 is a functional block diagram showing a configuration of a server device corresponding to at least one of the embodiments of the present disclosure.

FIG. 5 is a flowchart showing an example of circulation processing corresponding to at least one of the embodiments of the present disclosure.

FIG. 6 is a block diagram showing an example of a configuration of a circulation control system corresponding to at least one of the embodiments of the present disclosure.

FIG. 7 is a diagram showing a flow of actions of one user corresponding to at least one of the embodiments of the present disclosure.

FIG. 8 is a functional block diagram showing a configuration of a server device corresponding to at least one of the embodiments of the present disclosure.

FIG. 9 is a diagram showing an example of registration data corresponding to at least one of the embodiments of the present disclosure.

FIG. 10 is a diagram showing an example of a total result corresponding to at least one of the embodiments of the present disclosure.

FIG. 11 is a functional block diagram showing a configuration of a terminal device corresponding to at least one of the embodiments of the present disclosure.

FIG. 12 is a flowchart showing an example of circulation processing corresponding to at least one of the embodiments of the present disclosure.

FIG. 13 is a block diagram showing an example of a configuration of a circulation control system corresponding to at least one of the embodiments of the present disclosure.

FIG. 14 is a diagram showing a flow of actions of one user corresponding to at least one of the embodiments of the present disclosure.

FIG. 15 is a functional block diagram showing a configuration of a server device corresponding to at least one of the embodiments of the present disclosure.

FIG. 16 is a diagram showing an example of registration data corresponding to at least one of the embodiments of the present disclosure.

FIG. 17 is a functional block diagram showing a configuration of a terminal device corresponding to at least one of the embodiments of the present disclosure.

FIG. 18 is a flowchart showing an example of circulation processing corresponding to at least one of the embodiments of the present disclosure.

### DESCRIPTION OF EMBODIMENTS

Hereinafter, examples of embodiments of the present disclosure will be described with reference to the drawings. The various components in the examples of each embodiment described below can be appropriately combined as long as there is no contradiction or the like. In addition, the contents described as an example of a certain embodiment may be omitted in the other embodiments. The contents of operations and processing not related to the characteristic parts of each embodiment may be omitted. Further, an order of the various processing constituting the various flows described below is in no particular order as long as there is no contradiction or the like in the processing contents.

### First Embodiment

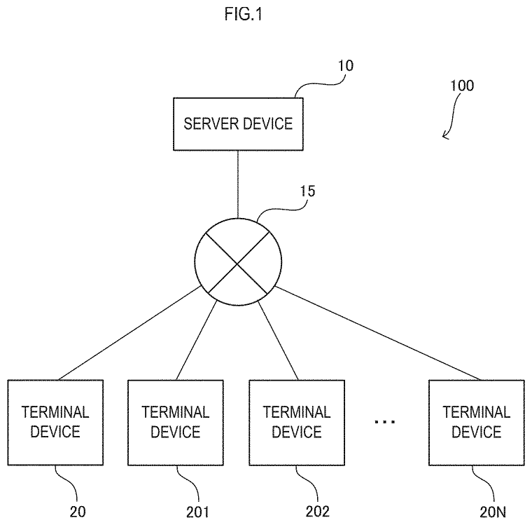

FIG. 1 is a block diagram showing an example of a configuration of a circulation control system 100 according to the embodiment of the present disclosure. As shown in FIG. 1, the circulation control system 100 includes a server device 10 and a plurality of terminal devices 20 and 201 to 20N (N is a random integer). The server device 10 and the plurality of terminal devices 20 and 201 to 20N are each connected to a communication network 15 such as the Internet. A configuration of the circulation control system 100 is not limited to this, and may be, for example, a configuration including a plurality of server devices.

The circulation control system 100 has various functions for controlling a progress of making each of a plurality of users circulate a plurality of destinations. A plurality of destinations mean places in the real space that the user should visit. In addition to walking, public transportation may be used for movement.

The circulation control system 100 of the example of the present embodiment is applied to, for example, a circulating type (migratory type) event such as a treasure hunt game. The treasure hunt game is an event in which a plurality of participants (users) solve a plurality of mysteries (questions) to search for treasure hidden in the real space. The treasure is a virtual treasure in the game which is hidden (disposed) in a plurality of places in the real space. The plurality of users can specify a place where the treasure is disposed by solving the plurality of questions. In the treasure hunt game, the plurality of users need to move on foot or the like to go around a plurality of places (destination) where the treasure is hidden and acquire all the treasures.

In the example of the present embodiment, a circulation order of the plurality of destinations of each user is not fixed, and the circulation control system 100 determines (designates). Each time one user visits one destination, the circulation control system 100 determines a destination to which the one user should visit next. Hereinafter, with respect to one user, among a plurality of destinations, the destination to which the one user should visit may be referred to as a designated destination at present. In the case of the treasure hunt game described above, each time one user visits one place and acquires a treasure, the circulation control system 100 determines a place (designated destination) of the next treasure that the one user should search for. In the example of the present embodiment, the server device 10 determines the designated destination. In addition, the server device 10 transmits information on the determined designated destination to the terminal devices 20 and 201 to 20N carried by each user. For example, in the case of the above-described treasure hunt game, information for notifying the user of a question indicating the place of the treasure corresponds to the information on the designated destination. Specifically, text data of the question sentence corresponds to the information on the designated destination. That is, in the case of the above-described treasure hunt game, each time one user visits one place and acquires a treasure, a question indicating a place (designated destination) of the next treasure that the one user should search for is delivered to a terminal device of the one user.

For example, a user P1 carrying the terminal device 20 moves toward a designated destination among a plurality of destinations. Then, the user transmits information indicating visiting the designated destination from the terminal device 20 to the server device 10. For example, in the case of the above-described treasure hunt game, identification information of the treasure disposed at the designated destination is transmitted as the information indicating visiting the designated destination.

In the example of the present embodiment, the server device 10 determines the designated destination to prevent many users from being temporarily crowded at one destination. Specifically, the server device 10 determines a designated destination of each user according to the congestion status of the plurality of destinations. The congestion status also includes a status that is expected to be congested. The congestion status of each destination is a status that is specified at least based on the information (designation information) on the destination (designated destination) to which each user should visit.

For example, in the above-described treasure hunt game, a case where a plurality of users circulate three destinations A1, A2, and A3 to acquire the treasure will be described. At present, the number of users who should visit the destination A1 is 10, the number of users who should visit the destination A2 is 5, and the number of users who should visit the destination A3 is 3. In this case, the destination A1 may be temporarily congested by gathering 10 users. Therefore, in a case of one user who circulates the three destinations A1, A2, and A3 from now on, the server device 10 may determine the destination A3, which has the smallest number of users, as the first destination (designated destination) of the one user.

The server device 10 is managed by an administrator of the game system, and has various functions for providing information on the progress of the circulation to the terminal devices 20 and 201 to 20N. The server device 10 provides, for example, the information on the destination (designated destination) to which the user should visit. In the example of the present embodiment, the server device 10 is configured by an information processing device such as a WWW server to provide the information on the progress of the circulation, and includes one or more storage media (storage units) for storing various information. In addition, the server device 10 also includes a control unit and the like composed of a central processing unit (CPU) and the like. Since the above-described configuration is a general configuration, detailed description thereof will be omitted. The storage unit may have a configuration built in the server device 10 or may be a storage device such as a database device separate from the server device 10.

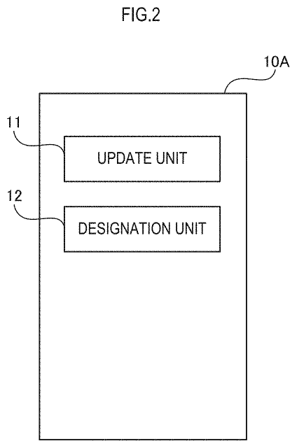

FIG. 2 is a functional block diagram showing a configuration of a server device 10A, which is an example of the configuration of the server device 10. The server device 10A includes at least an update unit 11 and a designation unit 12 by executing software (a circulation control program) for controlling the progress of the circulation stored in the storage unit by the control unit. The circulation control program also includes control data used to control the progress of the circulation.

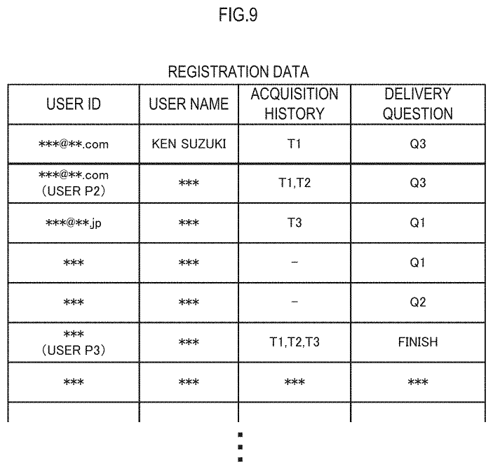

The update unit (update function) 11 updates the user information of each of the plurality of users registered in the storage unit of the server device 10A. The user information is information on the circulation of a plurality of destinations of the user (refer to, for example, the registration data shown in FIG. 9). The user information includes history information specifying an already visited destination and designation information specifying a destination (designated destination) to be visited. The history information is, for example, identification information of the already visited destination. The designation information is, for example, identification information of the destination to be visited.

When receiving the information indicating visiting the designated destination from the terminal devices 20 and 201 to 20N of any user, the update unit 11 updates the received history information of the user of the terminal device. When the designated destination of a certain user is determined by the designation unit 12, the update unit 11 updates the designation information of the user.

The designation unit (designation function) 12 determines a designated destination for each of a plurality of users. Specifically, the designation unit 12 determines, based on history information of one user, one destination that the one user has not visited yet among the plurality of destinations as a designated destination of the one user. However, the designation unit 12 determines a designated destination of each user according to the congestion status of the plurality of destinations. That is, the designation unit 12 determines a designated destination of one user according to the congestion status of a plurality of destinations among the destinations that the one user has not visited yet. As described above, the congestion status of each destination is a status that is specified at least based on the information (designation information) on the destination (designated destination) to which each user should visit. As in the above example, the designation unit 12 may determine a destination with the smallest number of users to be visited as a designated destination.

In addition, the designation unit 12 transmits information on the designated destination determined for one user to the terminal device of the one user. In the case of the above-described treasure hunt game, the information on the designated destination corresponds to the information for notifying the user of a question whose answer indicates the designated destination (treasure place), such as the text data of the sentence of the question. In addition, a name (text data) of the designated destination may be used as information on the designated destination. The information on the designated destination may be included in the control data in association with the identification information of the destination, for example.

Next, the terminal devices 20 and 201 to 20N will be described. Each of the terminal devices 20 and 201 to 20N is constituted by a user-portable terminal device such as a personal computer, a mobile phone terminal such as a smartphone, a personal digital assistants (PDA), or a tablet terminal. Accordingly, each of the terminal devices 20 and 201 to 20N moves with the movement of the user carrying the terminal device.

Each terminal device 20 and 201 to 20N includes the operation device (operation unit), the storage medium (storage unit), the control unit composed of the CPU, the display unit, the communication control unit, and the like. Since the above-described configuration is a general configuration, detailed description thereof will be omitted. In addition, software (application programs) and the like for performing various communications with the server device 10A regarding the circulation of the destination are stored in the storage units of the terminal devices 20 and 201 to 20N. By executing the above-described program, the terminal devices 20 and 201 to 20N receive, for example, the information on the designated destination from the server device 10A. In this case, for example, the information on the designated destination is displayed on the display units of the terminal devices 20 and 201 to 20N. In the case of the above-described treasure hunt game, a question sentence is displayed.

In addition, the terminal devices 20 and 201 to 20N transmit the information indicating visiting the designated destination to the server device 10A. As for the information indicating visiting the designated destination, any information can be specified as long as it is information that can specify that the user has visited the designated destination. For example, in the case of the above-described treasure hunt game, the identification information of the treasure acquired at the designated destination may be used as the information indicating visiting the designated destination.

Next, as an example of a configuration of the circulation control system 100, an operation of a circulation control system 100A including the server device 10A and the plurality of terminal devices 20 and 201 to 20N will be described.

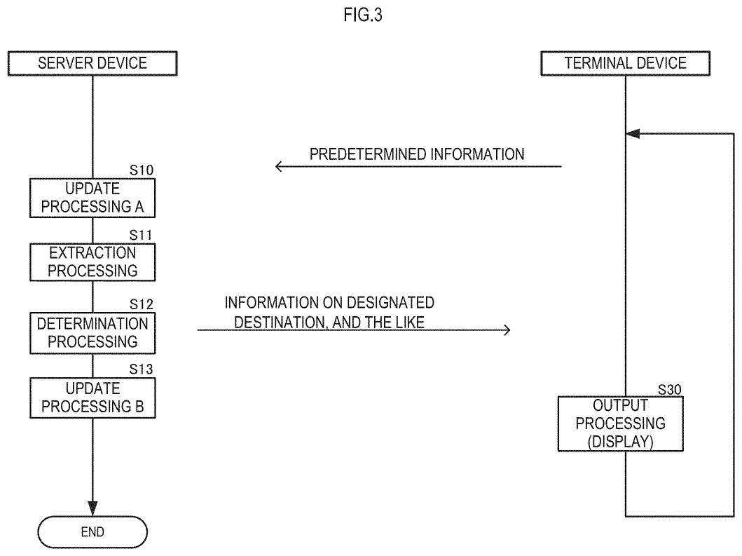

FIG. 3 is a flowchart showing an example of circulation processing executed by the circulation control system 100A. In the circulation processing in the example of the present embodiment, processing for determining a designated destination is performed for each of a plurality of users. FIG. 3 mainly describes processing of determining a designated destination and processing of updating user information, and some other processing may be omitted. Hereinafter, a case where the server device 10A and the terminal device 20 carried by the user P1 execute the circulation processing will be described as an example.

The circulation processing of the example of the present embodiment is executed, for example, when the server device 10A receives predetermined information from any of the terminal devices 20 and 201 to 20N.

The predetermined information corresponds to, for example, information on a designated destination visited by the user. In addition, the predetermined information corresponds to, for example, information of a circulation start request for the user to start the circulation of a plurality of destinations from now on. The terminal device 20 transmits the predetermined information together with the identification information of the user P1, for example.

The server device 10A executes update processing A (step S10). In the update processing A, the user information registered in the storage unit of the server device 10A is updated based on the received predetermined information. For example, when receiving information on the designated destination visited by the user P1 from the terminal device 20, the server device 10A updates the history information among the user information of the user P1. For example, identification information of the designated destination visited by the user P1 is added to the history information of the user P1. Then, the designation information of the user P1 is reset (set to an initial value). In addition, for example, when the user P1 receives the circulation start request from the terminal device 20, the server device 10A newly registers the user information of the user P1 in the storage unit of the server device 10A. For example, user information of user P1 including the identification information of user P1, history information in which the initial value is set, and designation information is generated.

Next, the server device 10A executes extraction processing (step S11). In the extraction processing, a candidate destination as a candidate of the designated destination is extracted. Specifically, based on the history information of the user P1, destinations that the user P1 has not visited yet are extracted as a candidate destination.

Thereafter, the server device 10A executes determination processing (step S12). In the determination processing, as described above, one candidate destination selected from among the above-described candidate destinations is determined as a designated destination according to the congestion status. That is, the destination to which the user P1 should visit is determined as a designated destination.

In addition, in the determination processing, the server device 10A transmits information on the determined designated destination to the terminal device 20. For example, in the case of the above-described treasure hunt game, the text data of the sentence of the question is transmitted. The terminal device 20 outputs (displays on the display unit) the received information on the designated destination (step S30). For example, in the case of the above-described treasure hunt game, a question sentence is displayed on the display unit of the terminal device 20.

After that, the server device 10A executes update processing B (step S13). In the update processing B, the designation information of the user information is updated. For example, the identification information of the designated destination determined in the determination processing of step S12 is registered as the designation information.

After that, the server device 10A ends the circulation processing. Regarding the circulation processing shown in FIG. 3, the same processing as that of the terminal device 20 is performed on the other terminal devices 201 to 20N.

As described above, as one aspect of the first embodiment, since the server device 10A is configured to include the update unit 11 and the designation unit 12, the destination to which the user should visit is set according to the congestion status. Accordingly, it is possible to prevent many users from being crowded and the destination being congested. Therefore, it is effective as an infection control of viruses and the like.

The circulation control system of the example of the above-described embodiment is not limited to application to a circulating type (migratory type) event such as a treasure hunt game. The circulation control system can be applied to any configuration as long as it is configured to allow each of a plurality of users to circulate a plurality of destinations. For example, in an attraction facility such as an amusement park, the circulation control system may be applied when a plurality of users ride a plurality of attractions (for example, a Ferris wheel).

In the example of the above-described embodiment, the server device executes the circulation control program to control the progress of the circulation, but the present disclosure is not particularly limited to this. The terminal device may execute a part of the processing executed by the server device shown in FIG. 3.

In the above-described example of the embodiment, the history information and the designation information are included in the user information and registered in the storage unit, but the present disclosure is not particularly limited to this. The history information and the designation information may be stored separately.

In the example of the above-described embodiment, the congestion status is specified based on the designation information of the user information, but other information (for example, the size of the destination, the number of people that can be accommodated) may be additionally referred to.

In the example of the above-described embodiment, an intention of the user is not reflected in the configuration in which the server device (designation unit) determines the designated destination, but a configuration that reflects the intention of the user may be adopted. For example, when determining the designated destination of one user, the designated destination may be selected by the one user. Specifically, the server device determines one or more candidate destinations from among one or more destinations that the one user has not visited yet, depending on the congestion status of a plurality of destinations. Then, the server device may determine the candidate destination selected by the one user using the operation unit from among the determined candidate destinations as the designated destination. For example, in the above-described treasure hunt game, in a case of one user who circulates three destinations A1, A2, and A3 from now on, the destination A3 with the smallest number of users and the destination A2 with the second smallest number of users are set as candidate destinations. Then, the one user selects any one of the candidate destinations (destination A2 and A3). The server device determines the selected destination as the designated destination. A destination other than the destination with the largest number of users may be set as a candidate destination. Further, the candidate destination may include at least the destination with the smallest number of users among the destinations that one user has not visited yet.

### Second Embodiment

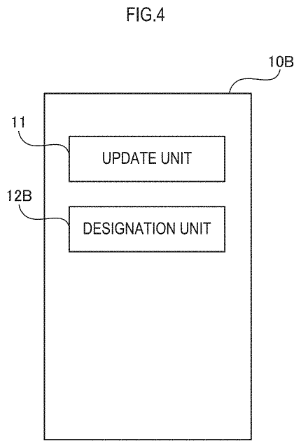

In the example of the present embodiment, a circulation control system 100B, which is an example of the circulation control system 100, will be described. The circulation control system 100B includes a server device 10B and a plurality of terminal devices 20 and 201 to 20N. FIG. 4 is a block diagram showing a configuration of the server device 10B, which is an example of the server device 10. In the example of the present embodiment, the server device 10B includes at least the update unit 11 and a designation unit 12B.

The update unit 11 updates the user information of each of a plurality of users registered in the storage unit of the server device 10B. The user information includes history information specifying an already visited destination and designation information specifying a destination (designated destination) to be visited. In addition, when receiving the information indicating visiting the designated destination from the terminal devices 20 and 201 to 20N of any user, the update unit 11 updates the received history information of the user of the terminal device. When the designated destination of a certain user is determined by the designation unit 12B, the update unit 11 updates the designation information of the user.

The designation unit 12B determines a designated destination for each of a plurality of users. Specifically, the designation unit 12B determines, based on history information of one user, one destination that the one user has not visited yet among the plurality of destinations as a designated destination of the one user. However, the designation unit 12B determines a designated destination of each user according to congestion status of the plurality of destinations. That is, the designation unit 12B determines a designated destination of one user according to the congestion status of a plurality of destinations among the destinations that the one user has not visited yet. The congestion status of each destination is a status that is specified at least based on the information (designation information) on the destination (designated destination) to which each user should visit. In the example of the present embodiment, when the designation unit 12B determines the designated destination of one user, the designation unit 12B determines, as the designated destination of the one user, the destination with at least the smallest number of users as the designated destination among the destinations that the one user has not visited yet. The designation unit 12B may specify the number of users based on the designation information of each user.

In addition, the designation unit 12B transmits information on the designated destination determined for one user to the terminal device of the one user. The information on the designated destination may be included in the control data in association with the identification information of the destination, for example.

Next, an operation of the circulation control system 100B will be described.

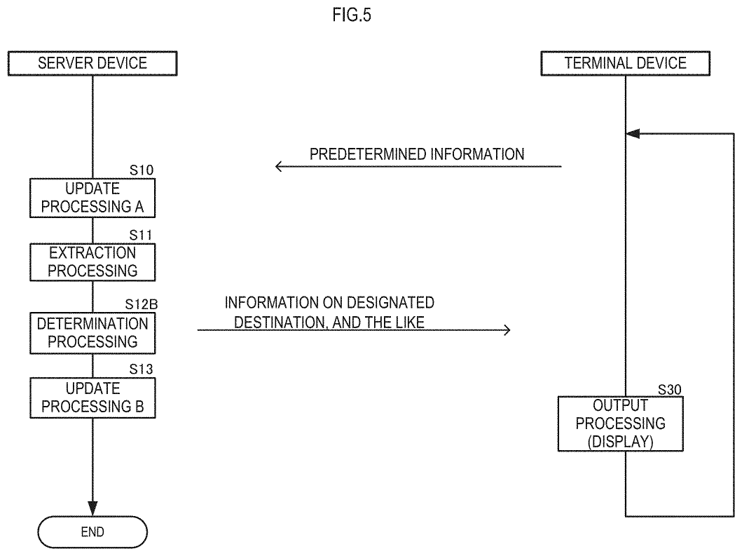

FIG. 5 is a flowchart showing an example of circulation processing executed by the circulation control system 100B. In the circulation processing in the example of the present embodiment, processing for determining a designated destination is performed for each of a plurality of users. FIG. 5 mainly describes processing of determining a designated destination and processing of updating user information, and some other processings may be omitted. Hereinafter, a case where the server device 10B and the terminal device 20 carried by the user P1 execute the circulation processing will be described as an example.

The circulation processing of the example of the present embodiment is executed, for example, when the server device 10B receives predetermined information from any of the terminal devices 20 and 201 to 20N.

The predetermined information corresponds to, for example, information on a designated destination visited by the user. In addition, the predetermined information corresponds to, for example, information of a circulation start request for the user to start the circulation of a plurality of destinations from now on. The terminal device 20 transmits the predetermined information together with the identification information of the user P1, for example.

The server device 10B executes update processing A (step S10). In the update processing A, the user information registered in the storage unit of the server device 10B is updated based on the received predetermined information. For example, when receiving information on the designated destination visited by the user P1 from the terminal device 20, the server device 10B updates the history information among the user information of the user P1. For example, identification information of the designated destination visited by the user P1 is added to the history information of the user P1. Then, the designation information of the user P1 is reset (set to an initial value). In addition, for example, when the user P1 receives the circulation start request from the terminal device 20, the server device 10B newly registers the user information of the user P1 in the storage unit of the server device 10B. For example, user information of user P1 including the identification information of user P1, history information in which the initial value is set, and designation information is generated.

Next, the server device 10B executes extraction processing (step S11). In the extraction processing, a candidate destination as a candidate of the designated destination is extracted. Specifically, based on the history information of the user P1, destinations that the user P1 has not visited yet are extracted as a candidate destination.

Thereafter, the server device 10B executes determination processing (step S12B). In the determination processing, one candidate destination selected from among the above-described candidate destinations is determined as a designated destination according to the congestion status. That is, the destination to which the user P1 should visit is determined as a designated destination. In the determination processing of the example of the present embodiment, the destination with the smallest number of users as the designated destination is determined as the designated destination of the user P1 at present.

In addition, in the determination processing, the server device 10B transmits information on the determined designated destination to the terminal device 20. For example, in the case of the above-described treasure hunt game, the text data of the sentence of the question is transmitted. The terminal device 20 outputs (displays on the display unit) the received information on the designated destination (step S30). For example, in the case of the above-described treasure hunt game, a question sentence is displayed on the display unit of the terminal device 20.

After that, the server device 10B executes update processing B (step S13). In the update processing B, the designation information of the user information is updated. For example, the identification information of the designated destination determined in the determination processing of step S12B is registered as the designation information.

After that, the server device 10B ends the circulation processing. Regarding the circulation processing shown in FIG. 5, the same processing as that of the terminal device 20 is performed on the other terminal devices 201 to 20N.

As described above, as one aspect of the second embodiment, since the server device 10B is configured to include the update unit 11 and the designation unit 12B, the destination to which the user should visit is set according to the congestion status. Accordingly, it is possible to prevent many users from being crowded and the destination being congested. Therefore, it is effective as an infection control of viruses and the like.

In the example of the above-described embodiment, an intention of the user is not reflected in the configuration in which the server device (designation unit) determines the designated destination, but a configuration that reflects the intention of the user may be adopted as in the first embodiment.

### Third Embodiment

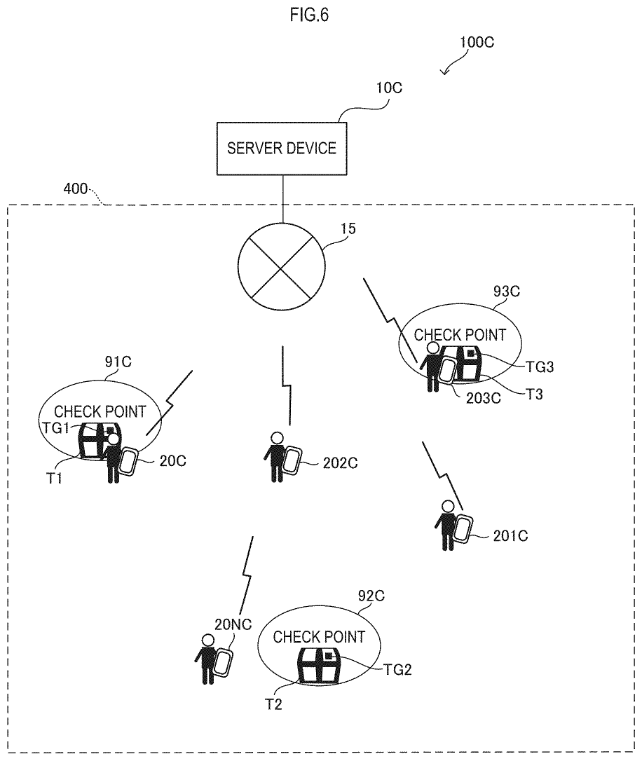

FIG. 6 is a block diagram showing a configuration of a circulation control system 100C, which is an example of the configuration of the circulation control system 100. The circulation control system 100C of the example of the present embodiment is applied to a treasure hunt game which is a circulating type event. The circulation control system 100C includes a server device 10C and terminal devices 20C and 201C to 20NC carried by a plurality of users. Each of the server device 10C and a plurality of terminal devices 20C and 201C to 20NC are wirelessly connected to a communication network 15 such as the Internet.

The treasure hunt game is an event in which a plurality of participants (users) solve a plurality of mysteries (questions) to search for treasure hidden in the real space. In the treasure hunt game, a plurality of users need to go around a plurality of places (destination) to acquire all the hidden treasures. In the example of the present embodiment, three treasures are hidden (disposed) in a certain area 400 in the real space. Specifically, treasures T1 to T3 are disposed at places (destinations) of check points 91C to 93C.

The check points 91C to 93C can be provided in, for example, a park, a plaza, a meeting place, a store, or the like. The area 400 may be any region in the real space that is randomly determined. For example, the area 400 corresponds to facilities such as attraction facilities and shopping malls.

Each user is given a total of three questions Q1 to Q3. An answer to question Q1 indicates the place of the check point 91C. An answer to question Q2 indicates the place of the check point 92C. An answer to question Q3 indicates the place of the check point 93C. Accordingly, each user can specify a place where all the treasures T1 to T3 are disposed by solving all the questions.

The treasures T1 to T3 are virtual treasures in the game and are boxes that imitate treasure boxes. Near filed communication (NFC) tags TG1 to TG3 are disposed in the treasures T1 to T3. When each user holds the user's terminal devices 20C and 201C to 20NC over the NFC tags TG1 to TG3, the user has acquired the treasures T1 to T3. That is, the terminal devices 20C and 201C to 20NC acquire the identification information of the treasures T1 to T3 from the NFC tags TG1 to TG3 by performing short-range wireless communication with the NFC tags TG1 to TG3. The identification information of the treasure T1 is recorded in the NFC tag TG1. The identification information of the treasure T2 is recorded in the NFC tag TG2. The identification information of the treasure T3 is recorded on the NFC tag TG3.

For example, when the terminal device 20C of the user P1 acquires the identification information of the treasure T1, the terminal device 20C transmits the identification information of the treasure T1 to the server device 10C. The server device 10C registers the received identification information of the treasure T1 in the user information (acquisition history) of the user P1. That is, the user P1 has acquired the treasure T1 by registering in the user information. The other terminal devices 201C to 20NC also have the same configuration as the terminal devices 20C.

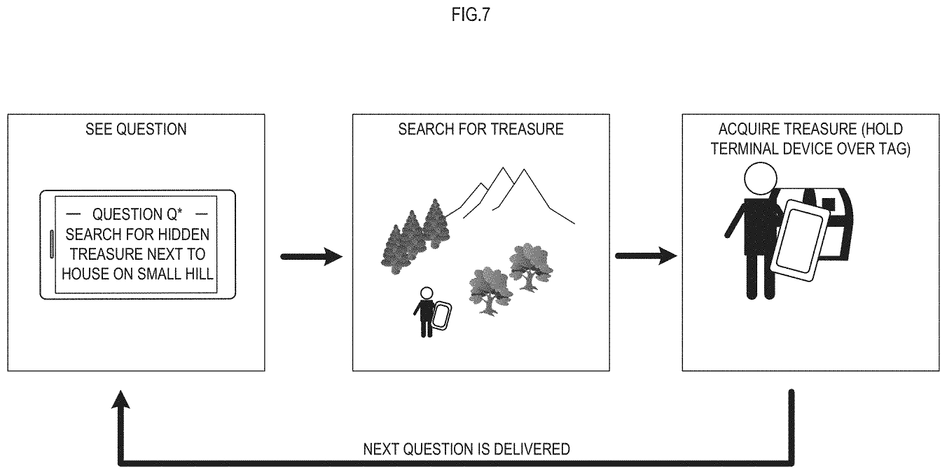

FIG. 7 is a diagram showing the flow of actions of one user P1 in the treasure hunt game. One question is delivered to the user P1 from the server device 10C to the user's terminal device 20C. The user P1 first sees one question displayed on the terminal device 20C. The user P1 searches a place (check point) where the treasure is disposed by solving the question. Then, the user P1 moves to the place where the treasure is disposed and acquires the treasure. Specifically, the user P1 acquires the identification information of the treasure by holding the terminal device 20C over the NFC tag disposed on the treasure. Then, the terminal device 20C transmits the acquired identification information of the treasure to the server device 10C.

After that, next one question is delivered from the server device 10C to the terminal device 20C of the user P1. The user P1 will also act in the same manner as described above for the next question. Finally, when the user P1 solves the three questions Q1 to Q3 and acquires the three treasures T1 to T3, the treasure hunt game ends.

In the present embodiment, as described above, the server device 10C delivers the questions Q1 to Q3 to the terminal devices 20C and 201C to 20NC. More specifically, the server device 10C transmits the text data of the sentences of the questions Q1 to Q3. The delivery of questions Q1 to Q3 is one question at a time in no particular order. As shown in FIG. 7, each time one question is solved and one treasure is acquired, another new question is delivered. The acquisition of one treasure means a state in which the identification information of the one treasure is registered in the user information (acquisition history).

The treasure hunt game is started by transmitting a game start request (circulation start request) from the terminal devices 20C and 201C to 20NC carried by each user to the server device 10C. The game start request includes, for example, information such as identification information of the user and a user name. Each user may, for example, input each information such as identification information of the user and a user name in the user's terminal device, and then transmit the game start request from the user's terminal device to the server device 10C. The server device 10C that has received the game start request additionally registers new user information in the storage unit, and delivers one question to the terminal device that has transmitted the game start request. As a result, the treasure hunt game is started.

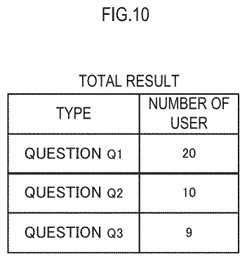

The circulation control system 100C (server device 10C) determines a destination (designated destination) to which each user should visit in order to prevent many users from being temporarily crowded at one destination (place where the treasure is disposed). In the example of the present embodiment, the server device 10C determines the designated destination by determining a question to be delivered from the plurality of questions Q1 to Q3. The answers to questions Q1 to Q3 indicate the check points 91C to 93C (places where the treasures T1 to T3 are disposed), which are the destinations to which the user should visit. Accordingly, the determination of the question to be delivered is the same as determining the designated destination. The server device 10C determines, among the questions Q1 to Q3, a question that is currently the least delivered to each user as a question to be delivered. For example, when the total result is as shown in FIG. 10, the question Q3 with a small number of users is determined as the question to be delivered to one user. In this case, this is because it is estimated that the check point 93C corresponding to the question Q3 is least likely to be crowded. The total result shown in FIG. 10 does not include the delivered number of questions that have already been cleared (the treasure has been acquired).

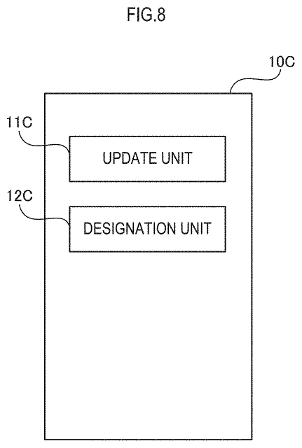

FIG. 8 is a block diagram showing a configuration of the server device 10C, which is an example of the server device 10. In the example of the present embodiment, the server device 10C includes at least an update unit 11C and a designation unit 12C.

The update unit 11C updates the user information of each of a plurality of users registered in the storage unit of the server device 10C. The user information is information on the circulation of a plurality of destinations of the user in the treasure hunt game. The user information of a plurality of users is registered as registration data in the storage unit of the server device 10C. FIG. 9 is a diagram showing an example of registration data.

The registration data is composed of fields such as a user ID, a user name, an acquisition history, and a delivery question. The user information of one user is registered in one record. The identification information of the user is registered in a user ID field. The identification information of the user corresponds to, for example, an e-mail address owned by the user. Text data of a user name is registered in a user name field.

The identification information of the treasure that the user has already acquired is registered in an acquisition history field. That is, in the acquisition history field, information specifying the destination that the user has already visited is registered. This is because the treasures T1 to T3 are disposed in different places, and the identification information of the treasures T1 to T3 functions as the identification information of the place (destination) where the treasures T1 to T3 are disposed. The acquisition history corresponds to the history information.

In a delivery question field, the identification information of the question currently being delivered to the user is registered. That is, in the delivery question field, the information specifying the designated destination, which is the destination to which the user should visit, is registered. This is because the answers to the questions Q1 to Q3 indicate the places (check points 91C to 93C) where the treasures T1 to T3 are disposed, and the identification information of the questions Q1 to Q3 functions as the identification information of the designated destination to which the user should visit. In a case of the user who has acquired all the treasures T1 to T3, the identification information indicating that the treasure hunt game has ended is registered in the delivery question field. In FIG. 9, for convenience of explanation, the characters “FINISH” are displayed instead of the identification information indicating that the treasure hunt game has ended. The information registered in the delivery question field corresponds to the designation information.

For example, in a case of the user P2 in FIG. 9, it is specified from the acquisition history that the treasures T1 and T2 have already been acquired. That is, it is specified that the user P1 has already visited the check points 91C and 92C (destinations). Further, it is specified from the delivery question that the user P2 is currently in a state where the question Q3 is being delivered and is searching for the treasure T3. That is, it is specified that the user P2 is currently in a state where the user should visit the check point 93C (designated destination).

In addition, for example, in a case of a user P3 in FIG. 9, it is specified from the acquisition history that the treasures T1 to T3 have already been acquired. That is, it is specified that the user P3 has already visited the check points 91C to 93C (destinations). Further, it is specified from the delivery question that the user P3 is in a state where the treasure hunt game is ended.

When receiving the information indicating visiting the designated destination (the identification information of the treasure) from the terminal devices 20C and 201C to 20NC of any user, the update unit 11C updates the received acquisition history of the user of the terminal device. Specifically, the update unit 11C additionally registers the received identification information of the treasure in the received acquisition history of the user of the terminal device. In addition, when the designated destination (question to be delivered) of one user is determined by the designation unit 12C, the update unit 11C updates the delivery question of the one user. Specifically, the update unit 11C registers the identification information of the question to be delivered in the delivery question of the one user.

The designation unit 12C determines a designated destination for each of a plurality of users. In the example of the present embodiment, the designation unit 12C determines a designated destination for each of the plurality of users by determining a question to be delivered for each of the plurality of users. Specifically, the designation unit 12C determines, based on the history information (acquisition history) of one user, as a question to be delivered to the one user, a question corresponding to one destination that the one user has not visited yet among the questions Q1 to Q3 corresponding to a plurality of destinations. That is, the designation unit 12C determines, based on the acquisition history of one user, a question that has not been delivered yet to the one user as a question to be delivered to the one user.

However, the designation unit 12C determines the question to be delivered to each user according to the congestion status of the plurality of destinations. The congestion status of each destination is a status that is specified at least based on the designation information (delivery question) of each user. In the example of the present embodiment, with respect to one user, the designation unit 12C determines, as a question to be delivered to the one user, a question corresponding to the destination with the smallest number of users as the designated destination among the destinations that the one user has not visited yet. Specifically, the designation unit 12C refers to the delivery question of the registration data, and totals the number of users to be delivered for each of the questions Q1 to Q3. That is, the designation unit 12C totals the number of users for each destination (check points 91C to 93C) to which each user should visit. From the total result, the designation unit 12C determines a question with the smallest number of users as a question to be delivered to the one user. For example, when the total result is as shown in FIG. 10, the designation unit 12C determines the delivered question Q3 with the smallest number of users as a question to be delivered to the one user.

In addition, the designation unit 12C transmits determined information on the designated destination of one user to the terminal device of the one user. In the example of the present embodiment, the information on the designated destination is, for example, text data of the question sentence of the question corresponding to the designated destination. The text data of the question sentence may be included in the control data.

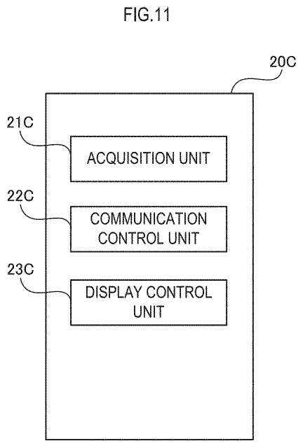

FIG. 11 is a block diagram showing a configuration of the terminal device 20C, which is an example of the terminal device 20. In the example of the present embodiment, the terminal device 20C is a smartphone. The terminal device 20C includes at least an acquisition unit 21C, a communication control unit 22C, and a display control unit 23C. The terminal devices 201C to 20NC have the same configuration as the terminal devices 20C.

The acquisition unit 21C acquires the identification information of the treasures T1 to T3 from the NFC tags TG1 to TG3 by short-range wireless communication. The communication control unit 22C receives the information and the like of the question delivered from the server device 10C. In addition, the communication control unit 22C transmits the game start request, the identification information of the acquired treasure, and the like to the server device 10C. The display control unit 23C causes the display unit to display information on the treasure hunt game such as the sentence of question.

Next, an operation of the circulation control system 100C will be described.

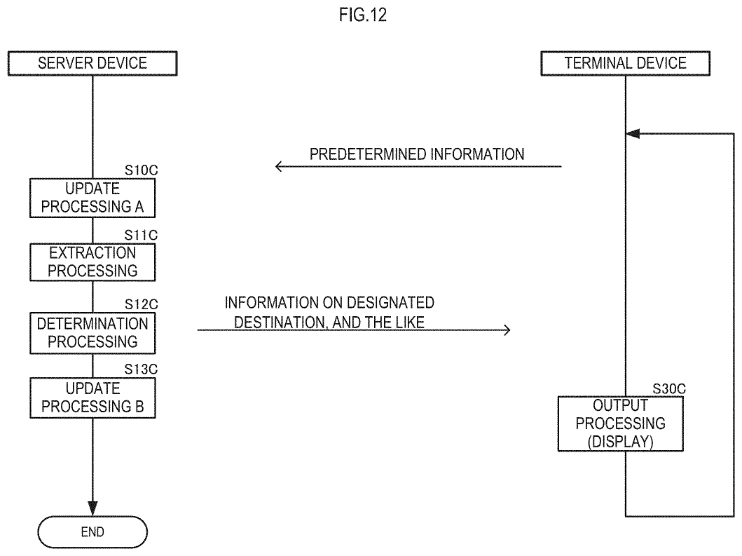

FIG. 12 is a flowchart showing an example of circulation processing executed by the circulation control system 100C. In the circulation processing in the example of the present embodiment, processing for determining a designated destination is performed for each of a plurality of users. Specifically, processing for determining a question corresponding to a designated destination is performed for each of a plurality of users. FIG. 12 mainly describes processing of determining a question and processing of updating user information, and some other processings may be omitted. Hereinafter, a case where the server device 10C and the terminal device 20C carried by the user P1 execute the circulation processing will be described as an example.

The circulation processing of the example of the present embodiment is executed, for example, when the server device 10C receives predetermined information from any of the terminal devices 20C and 201C to 20NC.

The predetermined information corresponds to the identification information (information on the designated destination) the treasure acquired by the user and the information on the game start request (circulation start request). The terminal device 20C transmits the updated information together with the identification information of the user P1.

The server device 10C executes update processing A (step S10C). In the update processing A, the user information registered in the storage unit of the server device 10C is updated based on the received predetermined information. For example, when receiving information (the identification information of the treasure) on the designated destination visited by the user P1 from the terminal device 20C, the server device 10C additionally registers the identification information of the treasure in the history information (acquisition history) of the user P1. Then, the server device 10C resets (sets to an initial value) the designation information (delivery question) of the user P1. When the identification information of all the treasures T1 to T3 is registered in the acquisition history, the identification information of the end of the game is registered in the delivery question of the user P1.

In addition, when receiving the game start request from the terminal device 20C, the server device 10C newly registers the user information of the user PI in the storage unit of the server device 10C. More specifically, the identification information of the user P1, the acquisition history in which the initial value is set, and the user information of the user P1 including the delivery question are additionally registered in the registration data shown in FIG. 9.

Next, the server device 10C executes extraction processing (step S11C). In the extraction processing, a candidate destination as a candidate of the designated destination is extracted. In the example of the present embodiment, destinations that the user P1 has not visited yet are extracted as a candidate destination based on the acquisition history of the user P1.

After that, the server device 10C executes determination processing (step S12C). In the determination processing, one candidate destination selected from among the above-described candidate destinations is determined as a designated destination according to the congestion status. In the example of the present embodiment, the server device 10C determines the question to be delivered to the user P1. As a result, the designated destination is determined. As described above, the server device 10C refers to the designation information (delivery question) of the registration data, and totals the number of users delivered for each of the questions Q1 to Q3. Then, based on the total result, the server device 10C determines the delivered question with the smallest number of users among the questions that have not been solved at present as the question to be delivered to the user P1.

In addition, in the determination processing, the server device 10C transmits information on the determined designated destination to the terminal device 20C. In the example of the present embodiment, the text data of the question sentence of the determined question is transmitted. The terminal device 20C displays the received information on the designated destination on the display unit (step S30C). As described above, the question sentence is displayed on the display unit of the terminal device 20C.

When all the identification information of the treasures T1 to T3 is registered in the acquisition history, the above-described extraction processing and determination processing are not executed.

After that, the server device 10C executes update processing B (step S13C). In the update processing B, the designation information (delivery question) of the user information is updated. Specifically, the identification information of the question determined in the determination processing of step S12C is registered as the delivery question of the user P1 in the registration data. When the above-described determination processing is not executed, the update processing B is not executed.

After that, the server device 10C ends the circulation processing. Regarding the circulation processing shown in FIG. 12, the same processing as that of the terminal device 20C is performed on the other terminal devices 201C to 20NC.

As described above, as one aspect of the third embodiment, since the server device 10C is configured to include the update unit 11C and the designation unit 12C, the destination (treasure to be searched) to which the user should visit is set according to the congestion status. Accordingly, it is possible to prevent many users from being crowded and the destination being congested. Therefore, it is effective as an infection control of viruses and the like.

In the example of the above-described embodiment, a configuration for acquiring the identification information of the treasure using the NFC tag is adopted, but the configuration is not particularly limited to this configuration. For example, a GPS function of the terminal device carried by the user may be used to acquire position information of a place where the treasure is disposed as the history information specifying the destination that the user has already visited.

In the example of the above-described embodiment, the designation unit directly determines the question to be delivered to each user, but it may be configured to determine the question to be delivered after determining the designated destination of each user.

In the example of the above-described embodiment, the text data which is the sentence of question is transmitted to the terminal device, but the text data is not limited to the text data. For example, in a case of a graphic question, graphic data (image data) may be transmitted to the terminal device.

In the example of the above-described embodiment, an intention of the user is not reflected in the configuration in which the server device (designation unit) determines the designated destination, but a configuration that reflects the intention of the user may be adopted as in the first embodiment. For example, when determining the designated destination of one user, the designated destination may be selected by the one user. Specifically, the server device determines one or more candidate destinations from among one or more destinations that the one user has not visited yet, depending on the congestion status of a plurality of destinations. Then, the server device may determine the candidate destination selected by the one user using the operation unit from among the determined candidate destinations as the designated destination. For example, in the above-described treasure hunt game, in a case of one user who circulates three destinations (check points 91 C to 93 C) from now on, a destination with the smallest number of users (check point 93C: question Q3) and a destination with the second smallest number of users (check point 92C: question Q2) are set as candidate destinations. Then, the one user selects any one of the candidate destinations (questions Q2 and Q3). The server device determines the selected destination (question) as the designated destination. A destination other than the destination with the largest number of users may be set as a candidate destination. Further, the candidate destination may include at least the destination with the smallest number of users among the destinations that one user has not visited yet.

### Fourth Embodiment

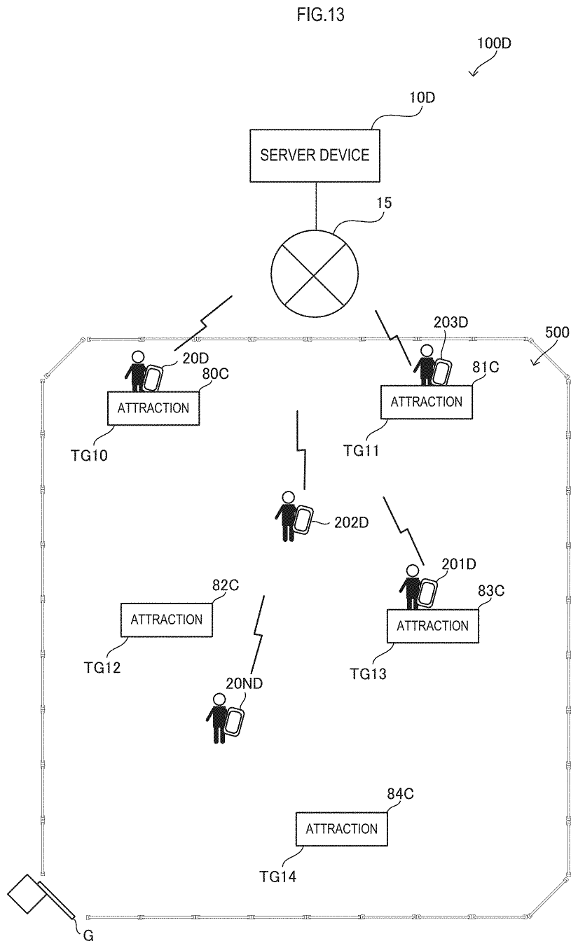

FIG. 13 is a block diagram showing a configuration of a circulation control system 100D, which is an example of the configuration of the circulation control system 100. The circulation control system 100D of the example of the present embodiment is applied to control the progress of the circulation of a plurality of attractions 80C to 84C in the amusement park (attraction facility) 500 in the real space. The circulation control system 100D includes a server device 10D and terminal devices 20D and 201D to 20ND carried by a plurality of users. Each of the server device 10D and a plurality of terminal devices 20D and 201D to 20ND are wirelessly connected to a communication network 15 such as the Internet.

In an amusement park 500, a plurality of attractions 80C to 84C such as a Ferris wheel and a roller coaster are disposed. The amusement park 500 is surrounded by fences. The user (visitor) can enter the facility from a gate G, which is the entrance and exit.

A plurality of users can ride a plurality of attractions 80D to 84D. The circulation control system 100D of the example of the present embodiment instructs the attractions to be ridden (to be visited) with respect to a plurality of attractions selected by each user. That is, the circulation control system 100D provides each user with a guidance about attractions to be ridden. Specifically, the circulation control system 100D instructs each user of one attraction to be ridden next each time the riding of the attraction is completed. .As a result, the circulation control system 100D causes each user to circulate a plurality of destinations (attractions).

The NFC tags TG10 to TG14 are disposed at an exit of the plurality of attractions 80D to 84D. The identification information of the disposed attractions is recorded in the NFC tags TG10 to TG14. Each user can acquire the attraction identification information by holding the user's terminal devices 20D and 201D to 20ND over the NFC tags TG10 to TG14. The identification information of the attraction 80D is recorded on the NFC tag TG10. The identification information of the attraction 81D is recorded on the NFC tag TG11. The identification information of the attraction 82D is recorded on the NFC tag TG12. The identification information of the attraction 83D is recorded on the NFC tag TG13. The identification information of the attraction 84D is recorded on the NFC tag TG14.

For example, when the terminal device 20D of the user P1 acquires the identification information of the attraction 80D, the terminal device 20D transmits the identification information of the attraction 80D to the server device 10D. The server device 10D registers the received identification information of the attraction 80D in the user information (riding history) of the user P1. That is, by registering in the user information, the user P1 has completed riding at the attraction 80D. The other terminal devices 201D to 20ND also have the same configuration as the terminal devices 20D.

The guidance about attractions is started by transmitting a guidance start request (circulation start request) from the terminal devices 20D and 201D to 20ND carried by each user to the server device 10D. The guidance start request includes, for example, information such as identification information of the user, a user name, and an attraction. The attraction information is the attraction information (identification information) selected by the user. Each user may, for example, input each information such as the identification information of the user, the user name, and the attraction in the user's terminal device, and then transmit the guidance start request from the user's terminal device to the server device 10D. The server device 10D which has received the guidance start request additionally registers the new user information in the storage unit, and transmits information on the attraction to be ridden (to be visited) first to the terminal device which has transmitted the guidance start request.

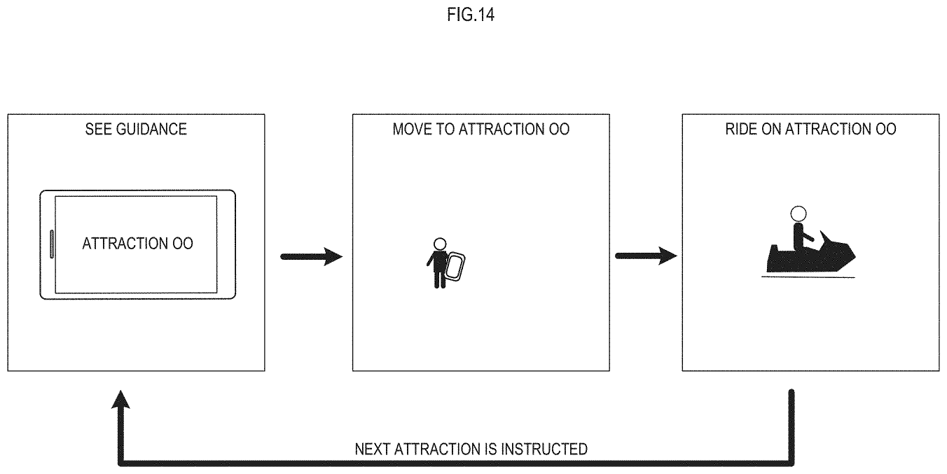

FIG. 14 is a diagram showing the flow of actions of one user P1 in the guidance about attractions. After the user P1 (terminal device 20D) makes the guidance start request, one attraction is delivered to the user P1 from the server device 10D to the user's terminal device 20D. The user P1 sees the guidance (attraction name) displayed on the terminal device 20D. The user P1 moves to the guided attraction. Then, the user P1 rides the attraction. After riding, the terminal device 20D is held over the NFC tag at an exit of the attraction to acquire the identification information of the attraction. Then, the terminal device 20D transmits the acquired attraction identification information to the server device 10D.

After that, the terminal device 20D of the user P1 is guided (instructed) by the server device 10D to one attraction to be ridden next. The user P1 also acts in the same manner as described above for the next attraction. Finally, when the user P1 has ridden all the selected attractions, the guidance about attractions ends.

The circulation control system 100D (server device 10D) determines a destination (designated destination) to which each user should visit in order to prevent many users from being temporarily crowded at one destination (attraction). That is, the server device 10D instructs each user about the attraction to be ridden.

Each user can select an attraction in a range of 2 or more and 5 or less, for example. In addition, the selectable number of attractions may be a fixed value.

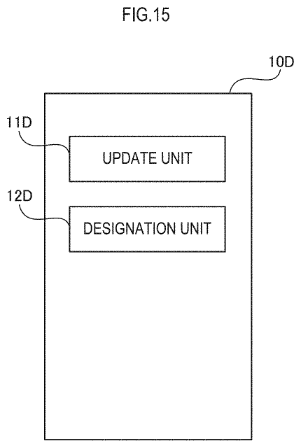

FIG. 15 is a block diagram showing a configuration of the server device 10D, which is an example of the server device 10. In the example of the present embodiment, the server device 10D includes at least an update unit 11D and a designation unit 12D.

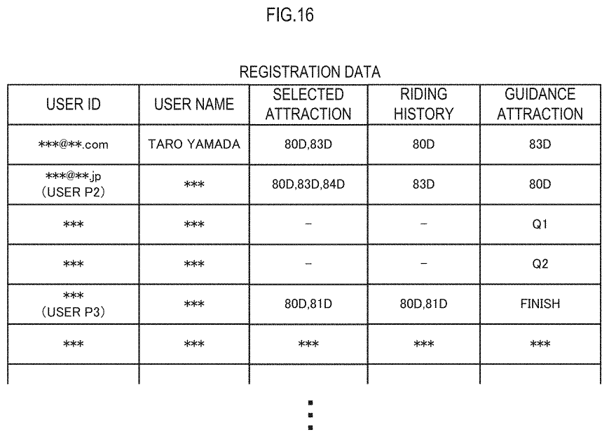

The update unit 11D updates the user information of each of a plurality of users registered in the storage unit of the server device 10D. The user information is information on the circulation of a plurality of destinations of the user in the guidance about attractions. The user information of a plurality of users is registered as registration data in the storage unit of the server device 10D. FIG. 16 is a diagram showing an example of registration data.

The registration data is composed of fields such as a user ID, a user name, a selected attraction, a riding history, and a guidance attraction. The user information of one user is registered in one record. The identification information of the user is registered in a user ID field. The identification information of the user corresponds to, for example, an e-mail address owned by the user. Text data of a user name is registered in a user name field.

The identification information of the attraction selected by the user is registered in a selected attraction field. The circulation control system 100D provides the guidance for a plurality of attractions registered as selected attractions.

In a riding history field, the identification information of the attraction that the user has already ridden is registered. That is, in the riding history field, the information specifying the destination that the user has already visited is registered. This is because the identification information of the attractions 80D to 84D functions as the identification information of the place where the attractions 80D to 84D are disposed. The riding history corresponds to the history information.

In a guidance attraction field, the identification information of the attraction currently being guided to the user is registered. That is, in the guidance attraction field, the information specifying the designated destination, which is the destination to which the user should visit, is registered. In a case of a user who has ridden all the selected attractions, the identification information indicating that the guidance has been ended is registered in the guidance attraction field. In FIG. 16, for convenience of explanation, the characters “FINISH” are displayed instead of the identification information indicating that the guidance has ended. The guidance attraction corresponds to the designation information.

For example, in the case of the user P2 in FIG. 16, the three attractions 80D, 83D, and 84D are the attractions that the circulation control system 100D guides the user P2. That is, the three attractions 80D, 83D, and 84D are the attractions selected by the user P2. In addition, it is specified from the riding history that the user P2 has already ridden the attraction 83D. Further, it is specified from the guidance attraction that the user P2 is currently in a state of being instructed to visit the attraction 80D. That is, it is specified that the user P2 is currently in a state where the user should visit the attraction 80D (designated destination).

In addition, for example, in the case of the user P3 in FIG. 16, the two attractions 80D and 81D are the attractions that the circulation control system 100D guides the user P3. Then, it is specified from the riding history that the user P3 has already ridden the attractions 80D and 81D. Further, as the designation information of the user P3, it is specified from the guidance attraction that the guidance has been ended.

When receiving the information indicating visiting the designated destination (the identification information of the attraction) from the terminal devices 20D and 201D to 20ND of any user, the update unit 11D updates the received riding history of the user of the terminal device. Specifically, the update unit 11D additionally registers the received identification information of the attraction in the received riding history of the user of the terminal device. In addition, when the designated destination (attraction) of one user is determined by the designation unit 12D, the update unit 11D updates the guidance attraction of the one user. Specifically, the update unit 11D registers the identification information of the determined designated destination (attraction) in the guidance attraction of the one user.

The designation unit 12D determines a designated destination for each of a plurality of users. In the example of the present embodiment, the designation unit 12D determines one attraction to be ridden for each of a plurality of users. Specifically, the designation unit 12D determines, based on the history information (riding history) of one user, one attraction which the one user has not visited yet among a plurality of attractions (selected attraction) selected by the one user as the attraction on which the one user should ride.

However, the designation unit 12D determines an attraction on which each user should ride according to the congestion status of a plurality of destinations (attractions). The congestion status of each destination is a status that is specified at least based on the designation information (guidance attraction) of each user. In the example of the present embodiment, with respect to one user, the designation unit 12D determines an attraction with the smallest number of users as an attraction on which the one user should ride among the attractions that the one user has not visited yet. Specifically, the designation unit 12D refers to the guidance attraction of the registration data, and totals the number of users being guided for each attraction 80D to 84D. That is, the designation unit 12D totals the number of users for each destination (attractions 80D to 84D) that each user is heading for riding. From the total result, the designation unit 12D determines the attraction with the smallest number of users as the attraction to be ridden by the one user.

In addition, the designation unit 12D transmits determined information on the designated destination of one user to the terminal device of the one user. In the example of the present embodiment, the information on the designated destination is, for example, text data of the name of the designated destination (attraction). The text data of the attraction may be included in the control data.

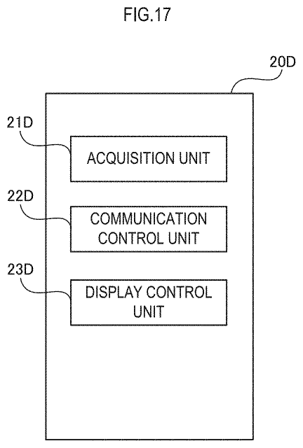

FIG. 17 is a block diagram showing a configuration of the terminal device 20D, which is an example of the terminal device 20. In the example of the present embodiment, the terminal device 20D is a smartphone. The terminal device 20D includes at least an acquisition unit 21D, a communication control unit 22D, and a display control unit 23D. The terminal devices 201D to 20ND have the same configuration as the terminal devices 20D.

The acquisition unit 21D acquires identification information of attractions from the NFC tags TG10 to TG14 by short-range wireless communication. The communication control unit 22D receives information and the like regarding the attractions transmitted from the server device 10D. In addition, the communication control unit 22D transmits the guidance start request, the acquired identification information of the attraction, and the like to the server device 10D. The display control unit 23D causes the display unit to display the name of the attraction and the like.

Next, an operation of the circulation control system 100D will be described.

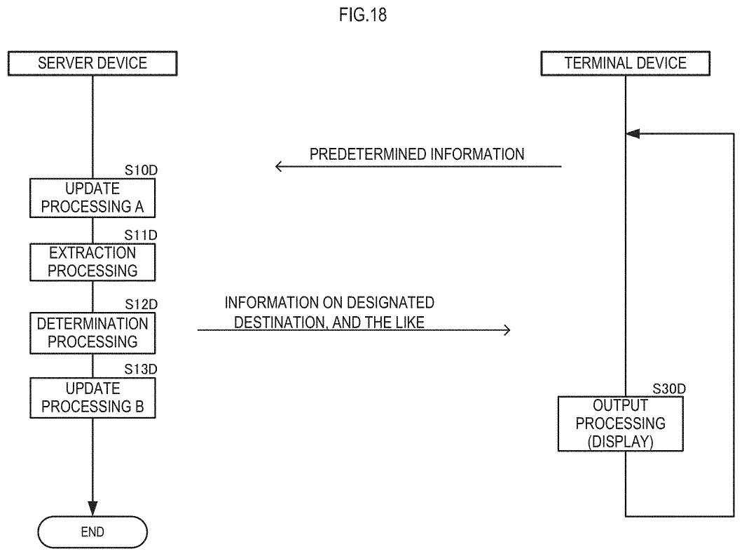

FIG. 18 is a flowchart showing an example of circulation processing executed by the circulation control system 100D. In the circulation processing in the example of the present embodiment, processing for determining a designated destination (attraction) is performed for each of a plurality of users. FIG. 15 mainly describes processing of determining an attraction and processing of updating user information, and some other processings may be omitted. Hereinafter, a case where the server device 10D and the terminal device 20D carried by the user P1 execute the circulation processing will be described as an example.

The circulation processing of the example of the present embodiment is executed, for example, when the server device 10D receives predetermined information from any of the terminal devices 20D and 201D to 20ND.

The predetermined information corresponds to identification information (information of the designated destination) of the attraction in which the user has appeared and information of the guidance start request (circulation start request). The terminal device 20D transmits the predetermined information together with the identification information of the user P1.

The server device 10D executes update processing A (step S10D). In the update processing A, the user information registered in the storage unit of the server device 10D is updated based on the received predetermined information. For example, when receiving information (identification information of an attraction) on the designated destination visited by the user P1 from the terminal device 20D, the server device 10D additionally registers the identification information of the attraction in the history information (riding history) of the user P1. Then, the server device 10D resets (sets to an initial value) the designation information (guidance attraction) of the user P1. When the identification information of all the attractions is registered in the riding history, identification information of the guidance end is registered in the guidance attraction of the user P1.

In addition, when receiving the guidance start request from the terminal device 20D, the server device 10D newly registers the user information of the user P1 in the storage unit of the server device 10D. Specifically, the identification information of the user P1, the selected attraction, the riding history in which the initial value is set, and the user information of the user P1 including the guidance attraction are additionally registered in the registration data shown in FIG. 16.

Next, the server device 10D executes extraction processing (step S11D). In the extraction processing, a candidate destination as a candidate of the designated destination is extracted. In the example of the present embodiment, a destination (attraction) that the user P1 has not visited yet (not ridden) is extracted as a candidate destination based on the selected attraction and the riding history of the user P1.

After that, the server device 10D executes determination processing (step S12D). In the determination processing, one candidate destination selected from among the above-described candidate destinations is determined as a designated destination according to the congestion status. In the example of the present embodiment, a destination (attraction) to which the user P1 should visit is determined. As described above, the server device 10D refers to the designation information (guidance attraction) of the registration data, and totals the number of users for each destination (attractions 80D to 84D) that each user heading for riding. Then, the server device 10D determines the attraction with the smallest number of users as the attraction on which the user P1 should ride at present from the total result.

In addition, in the determination processing, the server device 10D transmits information on the determined designated destination to the terminal device 20D. In the example of the present embodiment, the text data of the name of the determined attraction is transmitted. The terminal device 20D displays the received information on the designated destination on the display unit (step S30D). As described above, the name of the attraction is displayed on the display unit of the terminal device 20D.

When the identification information of all the attractions selected by the user P1 is registered in the riding history, the above-described extraction processing and determination processing are not executed.

After that, the server device 10D executes update processing B (step S13D). In the update processing B, the designation information (guidance attraction) of the user information is updated. The identification information of the designated destination (attraction) determined in the determination processing of step S12D is registered in the guidance attraction. When the above-described determination processing is not executed, the update processing B is not executed.

After that, the server device 10D ends the circulation processing. Regarding the circulation processing shown in FIG. 15, the same processing as that of the terminal device 20D is performed on the other terminal devices 201D to 20ND.

As described above, as one aspect of the fourth embodiment, since the server device 10D is configured to include the update unit 11D and the designation unit 12D, the destination (the attraction on which the user should ride) to which the user should visit is set according to the congestion status. Accordingly, it is possible to prevent many users from being crowded and the destination being congested. Therefore, it is effective as an infection control of viruses and the like.

In the example of the above-described embodiment, a configuration for acquiring the identification information of the attraction using the NFC tag is adopted, but the configuration is not particularly limited to this configuration. For example, a GPS function of the terminal device carried by the user may be used to acquire position information of a place where the attraction is disposed as the history information specifying the destination that the user has already visited.

In the example of the above-described embodiment, a configuration in which the user selects a plurality of attractions is used, but a configuration in which the user does not select the attractions may be used. In this case, for example, all attractions may be targeted to be guided to the user.

In the example of the above-described embodiment, the congestion status is specified based on the guidance attraction of the user information, but other information may be additionally referred to. For example, waiting time information until riding for each attraction may be additionally referred to.

In the example of the above-described embodiment, an intention of the user is not reflected in the configuration in which the server device (designation unit) determines the designated destination, but a configuration that reflects the intention of the user may be adopted as in the first embodiment. For example, when determining the designated destination of one user, the designated destination may be selected by the one user. Specifically, the server device determines one or more candidate destinations from among one or more destinations that the one user has not visited yet, depending on the congestion status of a plurality of destinations. Then, the server device may determine the candidate destination selected by the one user using the operation unit from among the determined candidate destinations as the designated destination. For example, in the guidance about attractions described above, in a case of one user who circulates three destinations (attractions 80D to 83D) from now on, a destination (attraction) with the smallest number of users and a destination (attraction) with the second smallest number of users are set as candidate destinations. Then, the one user selects one of the two candidate destinations (attractions). The server device determines the selected attraction as the designated destination. A destination other than the destination with the lamest number of users may be set as a candidate destination. Further, the candidate destination may include at least the destination with the smallest number of users among the destinations that one user has not visited yet.

### Appendix

The description of the above-described embodiment describes at least the following disclosure such that a person having ordinary knowledge in the field to which the invention belongs can carry out the invention.

[1]

A circulation control program for causing a server device that is connected to a terminal device carried by each of a plurality of users through a communication network to control a progress of making each of the plurality of users circulate a plurality of destinations, the circulation control program causes the server device to implement the following functions including an update function of updating user information of each of a plurality of users registered in a storage unit, the user information including history information specifying an already visited destination and designation information specifying a designated destination to be visited, and a designation function of determining the designated destination for each of a plurality of users, the designation function determining, based on the history information of one user, one destination that the one user has not visited yet as the designated destination of the one user, and transmitting information on the designated destination to a terminal device of the one user, in which the update function includes a function of updating the history information of one user when information indicating visiting the designated destination is received from the terminal device of the one user, and a function of updating the designation information of one user when the designated destination of the one user is determined by the designation function, and the designation function includes a function of determining the designated destination according to a congestion status of the plurality of destinations based on at least the designation information of each user.

[2]

The circulation control program according to [1], in which the designation function includes a function of determining, as a designated destination of one user, a destination having the smallest number of users as the designated destination specified based on at least the designation information of each user among the destinations that the one user has not visited yet, when determining the designated destination of the one user.

[3]

The circulation control program according to [1] or [2], in which the information on the designated destination is information for notifying a user of the terminal device of a question whose answer indicates the designated destination.

[4]

The circulation control program according to any one of [1] to [3], in which the terminal device acquires position information by performing short-range wireless communication with a communication device disposed at each of a plurality of destinations, the communication device storing the position information specifying the destination at which the communication device is disposed, and the update function includes a function of updating the history information of a user when the position information is received from the terminal device of the user as the information indicating visiting the designated destination.

[5]

The circulation control program according to any one of [1] to [4], in which the designation function includes a function of determining a new designated destination of a user each time the information indicating visiting the designated. destination is received from the terminal device of the user.

[6]

The server device on which the circulation control program according to any one of [1] to [5] is installed.

[7]

A circulation control system for controlling a progress of making each of a plurality of users circulate a plurality of destinations, the circulation control system including a terminal device carried by each of the plurality of users, and a server device connected to the terminal device through a communication network, the circulation control system including an updater configured to update user information of each of a plurality of users registered in a storage unit, the user information including history information specifying an already visited destination and designation information specifying a designated destination to be visited, and a designator configured to determine the designated destination for each of a plurality of users, the designator determining, based on the history information of one user, one destination that the one user has not visited yet as the designated destination of the one user, and transmitting information on the designated destination to a terminal device of the one user, in which the updater updates the history information of one user when information indicating visiting the designated destination is received from the terminal device of the one user, and updates the designation information of one user when the designated destination of the one user is determined by the designator, and the designator determines the designated destination according to a congestion status of the plurality of destinations based on at least the designation information of each user.

[8]

The circulation control system according to [7], in which the server device includes the updater and the designator, and the terminal device includes a communication controller configured to receive information on the designated destination from the server device and transmit information indicating visiting the designated destination to the server device.

[9]

A circulation control program for causing a computer of a terminal device carried by each of a plurality of users to implement a function of communicating with a server device having a function of controlling a progress of making each of the plurality of users circulate a plurality of destinations, the circulation control program causes the terminal device to implement a function of receiving information on a designated destination from the server device having the following functions including an update function of updating user information of each of a plurality of users registered in a storage unit, the user information including history information specifying an already visited destination and designation information specifying a designated destination to be visited, and a designation function of determining, the designated destination for each of a plurality of users, the designation function determining, based on the history information of one user, one destination that the one user has not visited yet as the designated destination of the one user, and transmitting information on the designated destination to a terminal device of the one user, in which the update function including a function of updating the history information of one user when information indicating visiting the designated destination is received from the terminal device of the one user, and a function of updating the designation information of one user when the designated destination of the one user is determined by the designation function, and the designation function including a function of determining the designated destination according to a congestion status of the plurality of destinations based on at least the designation information of each user.

[10]

The terminal device of a user on which the circulation control program according to [9] is installed.

[11]

A circulation control method for controlling a progress in which a terminal device carried by each of a plurality of users and a server device connected through a communication network make each of the plurality of users circulate a plurality of destinations, the circulation control method includes update processing of updating user information of each of a plurality of users registered in a storage unit, the user information including history information specifying an already visited destination and designation information specifying a designated destination to be visited, and designation processing of determining the designated destination for each of a plurality of users, the designation processing determining, based on the history information of one user, one destination that the one user has not visited yet as the designated destination of the one user, and transmitting information on the designated destination to a terminal device of the one user, the update processing is processing of updating the history information of one user when information indicating visiting the designated destination is received from the terminal device of the one user, and processing of updating the designation information of one user when the designated destination of the one user is determined by the designation processing, and the designation processing is processing of determining the designated destination according to a congestion status of the plurality of destinations based on at least the designation information of each user.

[12]

A circulation control method executed by a circulation control system for controlling a progress of making each of the plurality of users circulate a plurality of destinations, the circulation control system including a terminal device carried by each of a plurality of users, and a server device connected to the terminal device through a communication network, the circulation control method includes update processing of updating user information of each of a plurality of users registered in a storage unit, the user information including history information specifying an already visited destination and designation information specifying a designated destination to be visited, and designation processing of determining the designated destination for each of a plurality of users, the designation processing determining, based on the history information of one user, one destination that the one user has not visited ye as the designated destination of the one user, and transmitting information on the designated destination to a terminal device of the one user, the update processing is processing of updating the history information of one user when information indicating visiting the designated destination is received from the terminal device of the one user, and processing of updating the designation information of one user when the designated destination of the one user is determined by the designation processing, and the designation processing is processing of determining the designated destination according to a congestion status of the plurality of destinations based on at least the designation information of each user.

According to one of the embodiments of the present disclosure, in a configuration in which a user circulates a plurality of destinations, it is useful to prevent many users from being crowded and the destinations being congested.

What is claimed is:

1. A non-transitory computer-readable medium comprising a circulation control program causing a server device comprising a storage medium to execute functions, comprising:
connecting to a plurality of terminal devices through a communication network; and
controlling a progress of the plurality of terminal devices guiding a plurality of corresponding users circulate a plurality of destinations, including:
updating user information of each user of the plurality of users registered in the storage medium, the user information including history information specifying one or more already visited destinations and designation information specifying a designated destination to be visited;
determining the designated destination for each user of the plurality of users that each user has not visited yet based on the history information, and further according to a congestion status of the plurality of destinations; and
transmitting information on the designated destination to each terminal device of each user,
wherein updating the user information comprises:
updating the history information of each user when information indicating visiting the designated destination is received from each terminal device of each user; and
updating the designation information of each user when the designated destination of each user is determined.

2. The non-transitory computer-readable medium according to claim 1, wherein determining the designated destination for each user includes determining one or more candidate destinations from among the one or more destinations that one user has not visited yet according to the congestion status of the plurality of destinations, and determining the designated destination selected by each user from among the candidate destinations.

3. The non-transitory computer-readable medium according to claim 2, wherein
the candidate destination of each user is a designated destination of a smallest number of users among the destinations that the one user has not visited yet.

4. The non transitory computer-readable medium according to claim 1, wherein
the designated destination of each user is a designated destination of a smallest number of users among the destinations that each user has not visited yet.

5. The non-transitory computer-readable medium according to claim 1, wherein
the information on the designated destination includes information for notifying a user of the terminal device of a question having an answer indicative of the designated destination.

6. The non-transitory computer-readable medium according to claim 1, wherein
the terminal device is configured to receive position information by performing short-range wireless communication with each communication device at each destination of a plurality of destinations, each communication device storing the position information of each destination, and
wherein the information indicating visiting the designated destination includes the position information of the designated destination.

7. The non-transitory computer-readable medium according to claim 1, the functions further comprises:
determining a new designated destination of each user upon a receipt of the information indicating visiting the designated destination from the terminal device of each user.

8. A circulation control system comprising:
a plurality of terminal devices configured to guide a plurality of users of the plurality of corresponding terminal devices circulate a plurality of destinations;
a server device configured to connect to the plurality of terminal devices through a communication network and further configured to control a progress of the plurality of terminal devices guiding the plurality of corresponding users circulate the destinations;
a storage medium configured to register user information of each user of the plurality of users;
an updater configured to update the user information of each user of the plurality of users, including history information specifying one or more already visited destinations and designation information specifying a designated destination to be visited; and
a designator configured to determine the designated destination for each user of the plurality of users that each user has not visited yet based on the history information of each user and further according to a congestion status of the plurality of destinations, and further configured to transmit information on the designated destination to each terminal device of each user,
wherein the updater is configured to update the history information of each user when information indicating visiting the designated destination is received from each terminal device of each user, and further configured to update the designation information of each user when the designated destination of the each user is determined by the designator.

9. A non-transitory computer-readable medium comprising:
a communication control program causing a terminal device to execute functions, comprising:
communicating with a server device that is configured to control a progress of the terminal device guiding a user of the terminal device;
receiving information on a designated destination from the server device, the server being configured to:
update user information of each of a plurality of users registered in a storage medium, the user information including history information specifying one or more already visited destinations and designation information specifying a designated destination to be visited,
determine the designated destination for each user of the plurality of users that each user has not visited yet based on the history information, and further according to a congestion status of the plurality of destinations, and
transmit information on the designated destination to each terminal device of each user, wherein
the server is further configured to:
update the history information of each user when information indicating visiting the designated destination is received from each terminal device of each user, and
update the designation information of each user when the designated destination of each user is determined.
